(19) United States
(12) Patent Application Publication
(10) Pub. No.: US 2007/0027047 A1
(43) Pub. Date: Feb. 1, 2007

(54) Material in gel state

(75) Inventors: Masami Takemura, Hyogo (JP); Yasunori Hirai, Hyogo (JP); Mikako Kawaguchi, Hyogo (JP); Ryozo Inoue, Hyogo (JP); Yuko Sato, Hyogo (JP); Hiroki Takashima', Hyogo (JP); Nobuaki Yamaura, Hyogo (JP); Akiko Harada, Hyogo (JP); Eri Nagaito, Hyogo (JP); Yukiko Isaka, Hyogo (JP); Hiromitsu Adachi, Hyogo (JP); Hirohisa Yokoya, Hyogo (JP); Hiroyuki Kashihara, Hyogo (JP); Yasuko Umetani, Hyogo (JP); Mayumi Matsushita, Hyogo (JP); Ryo Iwakiri, Hyogo (JP); Shoichi Komoto, Okayama (JP)

Correspondence Address: KODA & ANDROLIA, 2029 CENTURY PARK EAST, SUITE 1140, LOS ANGELES, CA, 90067, US

(73) Assignee: Earth Chemical Co., Ltd., Tokyo (JP)

(21) Appl. No.: 10/569,897

(22) PCT Filed: Oct. 22, 2004
(86) PCT No.: PCT/JP04/15694

§ 371 Date: Feb. 28, 2006

(30) Foreign Application Priority Data
Oct. 31, 2003 (JP) 2003-373141
Aug. 31, 2004 (JP) 2004-253604

(51) Int. Cl. C11D 3/50

(52) U.S. Cl. 510/101

(57) ABSTRACT

An object of the present invention is to provide a multifunctional gel material including a gel and solid materials, in which the solid materials are moderately dispersed within the gel by adjusting the specific gravities of the gel and the solid materials, or in which the solid materials are always arranged in the same predetermined positions within the gel by dispersing them to the predetermined positions with a positioning means. To achieve this object, the solid materials are dispersed within the gel by using any means. Specifically, the solid materials are dispersed within the gel by adjusting the specific gravity of the solid materials with the specific gravity of the gel. Furthermore, the solid materials are moderately dispersed within the gel by being appropriately arranged by a positioning means.

### FIELD OF THE INVENTION

The present invention relates to a gel material that may be used as a gel deodorizer, a gel fragrance, a gel micro-biocide, a gel pesticide or the like.

### DESCRIPTION OF THE RELATED ART

Traditionally, this type of gel material, for example, a transparent oil gel 23 containing flagrant materials, has been provided by being filled in a transparent or translucent see-through container 21, into which a natural plant ornament 22 is placed in advance, as shown in FIG. 10. (Patent Publication 1)

[Patent Publication 1]

Japanese Patent Application Publication Laid-Open No. JP-H11-276567 (p. 2, p. 3, FIG. 2)

### SUMMARY OF THE INVENTION

### Objects of the Invention

Thus, the conventional gel material as described above gives a good appearance through the transparent or translucent see-through container in which the natural plant ornament is trapped in transparent oil gel in a stable manner.

However, such conventional gel material has a problem with holding the natural plant ornament in the gel in a balanced manner, that is, when the natural plant ornament is arranged in the gel, it tends to move up or down due to its specific gravity since the specific gravity of the natural plant ornament is not taken into consideration in the conventional gel material.

Furthermore, the conventional gel material as described above also has a problem with holding a natural plant ornament always at the same predetermined position in the gel.

In addition, the conventional gel material as described above has another problem that the gel material has no other functions than being used as a fragrance. The existence of the natural plant ornament in the gel material merely helps a good appearance of the gel material.

It is, therefore, an object of the present invention to provide a multifunctional gel material including a gel and solid materials, which allows for moderate dispersion of the solid materials within the gel by adjusting the specific gravities of the gel and the solid materials, or which allows for always the same arrangement of the solid materials in the gel by dispersing them at the predetermined positions with a positioning means.

### DETAILED DESCRIPTION OF THE INVENTION

To achieve the object of the invention, the present invention provides a gel material which includes a gel and solid materials in which the solid materials are moderately dispersed in the gel by any means.

More specifically, the gel material of the present invention allows for moderate dispersion of the solid materials in the gel by adjusting the specific gravity of the solid materials with the specific gravity of the gel. For example, there may be provided a gel material which includes a gel and three types of solid materials, a solid material whose specific gravity is equal to the specific gravity of the gel, a solid material whose specific gravity is higher than the specific gravity of the gel, and a solid material whose specific gravity is lower than the specific gravity of the gel, mixed therein. This allows the solid materials to be equally dispersed in the upper, middle and lower sides of the gel.

The gel material of the present invention further allows for moderate dispersion of the solid materials within the gel by arranging the solid materials at appropriate positions in the gel with a positioning means. For example, the solid materials are dispersed and arranged at the predetermined positions in the gel by using at least any one of the positioning means of transmutable skewers, frames, nets and containers, so that the solid materials can always be provided at the same positions in the gel.

In addition, the gel material of the present invention may further have a lamé material blended into the gel to add the effect peculiar to the lamé material that allows light to scatter and disperse within the gel.

In the present invention, the gel may be either an oil or aqueous gel, or may be any type of substance which is either in gel form, or not in gel form as long as it can be gelatinized by a gelling agent. As the gelling agent, at least one agent may be selected from agar (with a solidification point of between 37 and 41° C., preferably between 38 and 40° C. for retention of water), carrageenan, locust bean gum, guar gum, gum acacia, gelatin, pectin, starch, carboxymethylcellulose, hydroxymethylcellulose, hydroxypropylcellulose, polyvinylalcohol polyalkylamides, polyacrylic acids and the like. Preferably, the gelling agent is a mixture of agar, carrageenan and locust bean gum, or agar alone. As the agar; for example, High elastic agar YAMATO, UM-11KS or S8 (both from Ina Food Industry Co., Ltd) may be used. At least one of Gelidium amansii, Gracilaria asiatica, Pterocladia capillacea and Ahnfeltia plicata may be used as red algae, which is raw material of the agar. Any Gelidium amansii originated from Japan, Morocco, Chili Korea or Spain, and any Gracilaria asiatica originated from Japan, Chili South Africa or Argentine, or cultivated in Chili, Taiwan, Vietnam, China or the like may be used. Moreover, in order to improve the shape retention of the gel, lactate salt (sodium, potassium, calcium or magnesium salt) can be added. Among these lactate salts, calcium lactate is preferred. However, when agar is used alone, it is not necessary to add lactate salt.

The gelling agent may be mixed in an amount ranging from 0.5 to 3 weight % of the total weight, preferably 1 to 2.5 weight % of the total weight.

The agar may be mixed in an amount ranging from 5 to 95 weight % of the total weight of the gelling agent; preferably 10 to 50 weight % of the total weight of the gelling agent.

The lactate salt may be mixed in an amount ranging from 5 to 40 weight % of the total weight of the gelling agent, preferably 10 to 30 weight % of the total weight of the gelling agent.

In the present invention, the solid materials, whose specific gravity is adjusted with the specific gravity of the gel in the gel material, include those that can retain an aqueous or oil-based functional compound. The solid materials further include, but are not limited to, functional resins (coated with a functional coating material (e.g. an activated-carbon coating), or mixed with a deodorizing agent, an air freshening agent, a micro-biocidal agent, a grant material or the like), functional mineral powder (e.g. aluminum hydroxide, magnesium oxide), zeolite, silica, silica gel, colloidal silica, titanium (e.g. photocatalysts), coal charcoal (soft charcoal and hard charcoal), charcoal powder, Bincho charcoal, sawdust charcoal, oak charcoal, bamboo charcoal, activated charcoal, coconut charcoal, activated coconut shell charcoal, coconut shell activated charcoal, impregnated charcoal (with improved deodorizing performance for ammonia odor by addition of acid), mousou bamboo powder, charcoal powder, bamboo charcoal powder, activated carbon fiber, a Bincho charcoal sheet and a synthetic absorbent. They may be used in the native forms or in any forms, such as spherical, hemispherical, cubic, cuboid, oval, circular, rectangular and star-like forms, as long as they do not hamper the implementation of the present invention.

The gel may be transparent, translucent or opaque, but is preferred to be transparent or translucent, especially when the lamé material is blended therein. Also, various functional compounds, additives and solvents may be added to the gel. As examples of them, there are an insect repellent, an insecticide, a repellent, an ovicide, a synergist, a stabilizing agent, a moisturizing agent, a preservative, a dye, a fragrant material, a microbiocide, an acaricide, a deodorizer, a fragrance, an air freshener, a deodorizing agent. Specifically, cold volatile essential oils for the insect repellents include at least one of rose oil, jasmine oil, patchouli oil, carnation oil, mint oil, orange oil, bergamot oil, pecheva oil, spearmint oil, eucalyptus oil, cubeba oil, mint oil, lemongrass oil, rosemary oil, lavender oil, lemon oil, cedar oil, pine oil, tea tree oil, cassia oil, ylang ylang oil, geranium oil, citronella oil, fennel oil, pine needle oil, Turpentine oil, anise oil, orange peel oil, clove oil, sandalwood oil, camphor oil, cypress oil, calamus oil, chenopodium oil, ocotea oil, spike oil, cajeput oil and cedarwood oil. Alternatively, one or more components contained in these essential oils, such as menthol, phytoncide, limonene, pinene, anetole, carvone, cineole, terpineole, eugenole, hinokitiol, linalool, safrole, cedrene and asarone, may be mixed into the gel. In particular, it is preferable that at least one of α-pinene, spearmint oil, eucalyptus oil, cubeba oil, mint oil, lemongrass oil, pine oil, rosemary oil and lavender oil is mixed into the gel, since these are helpful to keep fabric pests or moths away from clothing and prevent their invasion and egg laying. The insecticides include empenthrin, transfluthrin, metofluthrin, paradichlorobenzene, 2,6,6-trimethyl-2,3-epoxybicyclo[3,1,1]heptane, ε-caprolactam, imidazole, vanillin, itaconic acid, angelica lactone, 1,7,7-trimethyltricyclo[2,2,1,0]heptane, 6,6-dimethyl-2-methylbicyclo[3,11]heptane, dehydroacetic acid, mandelic acid and 2-ethylidene-5 (or 6) formyl-bicyclo[2,2,1]heptane. The repellants include Deet, straight chain fatty acid esters with carbon number 10-11 and having the boiling temperature of between 200 and 230° C., camphor, naphthalene, cyclohexane, oxime, fluorine and acetonaphthene. In addition, at least one of propyleneglycol monopropyl ether, propyleneglycol monobutyl ether, dipropyleneglycol monopropyl ether, dipropyleneglycol monobutyl ether, dipropyleneglycol dimethyl ether, ethyleneglycol monoisobutyl ether, diethyleneglycol dibutyl ether, diethyleneglycol dimethyl ether, triethyleneglycol dimethyl ether, saturated branched-chain hydrocarbons with carbon number 7-13, limonene, pinene, anetole, lemon oil bergamot oil, fennel oil, pine needle oil, field mint oil, Turpentine oil, anise oil, cedarwood oil, lavender oil, eucalyptus oil, tea tree oil, lemongrass oil, spearmint oil, geranium oil, rosemary oil and Thujopsis dolabrate oil may be used as ovicides to be mixed into the gel. Furthermore, agents such as IBTA and IBTE may be added as synergists; agents such as BHT and BHA may be added as stabilizing agents; glycerin and the like may be added as moisturizing agents; salicylic acid, ester-p-Hydroxybenzoate and the like may be added as preservatives; Brilliant Blue FCF, Fast Green FCF, Quinolin Yellow WS and the like may be added as dyes; and vanillin, phenylethyl alcohol, piperonal and the like may be added as fragrant materials.

Each of the above components which can be mixed into the gel may be in an amount ranging from 0.5 to 40 weight % of the total weight of the gel, preferably ranging from 1 to 30 weight % of the total weight of the gel. To emulsify, scatter or dissolve these components, at least one of the followings may be used: lower alcohols, including ethanol and propyl alcohol; polyvalent alcohols, including glycerin, diethylene glycol, butylene glycol, propylene glycol, sorbitol and xylitol; and surfactants, including polyoxyethylene fatty acid ester, polyoxyethylene sorbitan fatty acid ester, polyoxyethylene sorbit fatty acid ester and polyoxyethylene alkyl ether. These alcohols and surfactants may be mixed into the gel in an amount ranging from 0.5 to 20 weight % of the total weight of the gel, preferably ranging from 1 to 10 weight % of the total weight of the gel.

The gel material of the present invention is usually utilized with being housed in a container which is provided with an emitting means such as openings and gas permeable membrane. Preferably, a see-through type of container is used as the container, which is made of, for example, polypropylene, polyethylene, polyethylene terephthalate (PET) and glass.

In the present invention, the term “lamé material” is used as a generic term referring to powder having polarizing ability, which is produced by cutting sheets whose polarizing ability is conferred by stacking film, aluminum and the like in layers. Typically, resins, such as PET, polyethylene, polyester and polymethacrylate, are used to stack them in layers. Laminated film stained with pigment may be also used. In the present invention, the lamé material also includes powder which has no polarizing ability but gives the appearance of scattering and dispersing light, for example, white particles of aluminum hydroxide or the like. There is no limitation imposed on the material, shape, size and type of the lamé material, as long as they do not hamper the implementation of the invention and the specific gravities of the lamé material and the gel are adjusted. To prepare the lamé material being dispersed, the lamé material is added to and scattered into a soluble gel solution in which a predetermined volume of commercially available aqueous paint is added and scattered in advance. After scattering the lamé material, the solution is gently stated so as not to destroy the lamé material, and it then may be filled in bottles and the like. Alternatively, water-insoluble powder may be dispersed in the gel.

In the present invention, the meaning of the term “dispersion” includes both an equally dispersed state and an unequally dispersed state. The solid materials may have concavities and convexities or openings and projections on their surface so as to be attached to each other, or they may be attached directly to each other. Alternatively, the solid materials may be arranged at appropriate positions in the gel by using a transmutable frame, net or container into which the solid materials are provided. Transmutable skewers may also be used to arrange the solid materials at appropriate positions in a skewered state.

An exemplary process for preparation of the gel material of the present invention is as follows: Solid materials are placed into a container, to which a solution made by mixing a solution of a gelling agent with a solution in which an insect repellent essential oil is emulsified with a surfactant are added and mixed with agitation, followed by cooling and solidifying the mixture. This method is provided for illustrative purpose only, and the preparation method is not limited thereto. Other methods are also possible as long as the gel material can be obtained by them.

In the present invention, when charcoal is used as the solid materials, the gel material may be produced by the following steps: first, hardening charcoal powder or activated carbon fiber into a spherical or oval form by using binder, or preparing a spherical charcoal-containing gel; placing the hardened charcoal or the charcoal-containing gel into a container, into which a gel solution separately prepared is poured; and then cooling and solidifying the mixture. Specifically, water is weighed and added into a container and a gelling agent is scattered into the water and stirred for 20 to 30 minutes at 90° C. or higher for dissolution. After cooling the solution down to 50° C., Biosite and glycerin are added to and dissolved in the solution. A predetermined volume of an undiluted solution of the charcoal is further added to and well scattered in the solution by agitation. This charcoal-containing gelatinized solution cooled down to 45° C. is then added dropwisely to an ice-chilled solution (a solution for solidifying gel, such as Isopar H that is supplemented with chloroform for adjusting the specific gravity thereof di-n-butyl adipate and so on.) by using a pipette and such. The charcoal-containing gelatinized solution is shaped into a spherical form by the surface tension thereof and is solidified while it is slowly falling down within the ice-chilled solution. The solidified gel is removed from the solution and used as the charcoal-containing gel. The hardness of the charcoal-containing gel may be adjusted by adding xanthan gum, glucomannan or gellan gum into the charcoal-containing gel. If the charcoal-containing gel in a cubic form is desirable, the charcoal-containing gel is poured into a tray to be solidified and shaped into the form of a plate, which is then cut into a predetermined size and shape.

As being constituted as described above, the gel material of the present invention allows for moderate dispersion of the solid materials within the gel by adjusting the specific gravity of the solid materials with the specific gravity of the gel. The gel material of the present invention also allows for always the same arrangement of the solid materials in the gel by dispersing the solid materials at the predetermined positions by attaching them to each other or by using at least one of the positioning means of transmutable skewers, frames, nets and containers. In addition, the gel material of the present invention further allows for providing the effect peculiar to the lamé material, which makes light scatter and disperse within the gel, by having the lamé material whose specific gravity is adjusted with that of the gel.

### BRIEF DESCRIPTION OF THE DRAWINGS

FIG. 1 is a perspective illustration of the semi-cross sectional view of the first embodiment of the gel material of the present invention.

FIG. 2 is a perspective illustration of the semi-cross sectional view of the second embodiment of the gel material of the present invention.

FIG. 3 is a perspective illustration of the semi-cross sectional view of the third embodiment of the gel material of the present invention.

FIG. 4 is a perspective illustration of the semi-cross sectional view of the fourth embodiment of the gel material of the present invention.

FIG. 5 is a perspective illustration of the semi-cross sectional view of the fifth embodiment of the gel material of the present invention.

FIG. 6 is a perspective illustration of the semi-cross sectional view of the sixth embodiment of the gel material of the present invention.

FIG. 7 is a perspective illustration of the semi-cross sectional view of the seventh embodiment of the gel material of the present invention.

FIG. 8 is a perspective illustration of the semi-cross sectional view of the eighth embodiment of the gel material of the present invention.

FIG. 9 is a perspective illustration of the semi-cross sectional view of the ninth embodiment of the gel material of the present invention.

FIG. 10 is a cross sectional view illustrating an example of the conventional gel material.

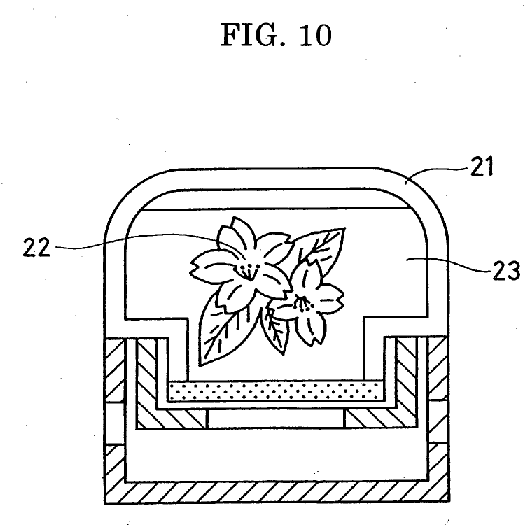

### DETAILED DESCRIPTION OF THE PREFERRED EMBODIMENTS

The best mode for implementing the gel material of the present invention is illustrated in detail below.

Tables 1 and 2 show specific exemplary formulations 1 and 2 of the gel used in the gel material of the present invention, in which an insect repellent gel is used as the gel. Tables 3 and 4 show specific exemplary formulations 1 and 2 of the solid materials used in the gel material of the present invention, in which charcoal-containing gels are used as the solid materials. It should be understood that the insect repellent gel and the charcoal-containing gels are not limited to the formulations shown in the tables.

The gel material of the present invention produces the insecticidal, deodorizing and air freshening effects when the insect repellent gel shown in Tables 1 and 2 is mixed with the charcoal-containing gels shown in Tables 3 and 4. The mixing ratio of the insect repellent gel to the charcoal-containing gels may be in the range from 6:4 to 9.5:0.5, and preferably 9:1.

TABLE 1
Formulation 1 of Insect Repellent Gel

| | | Preferred |
|---|---|---|
| | Blending | Blending |
| | Quantity | Quantity |
| Components | (weight %) | (weight %) |
| Volatile insecticidal component | 0.01˜40 | 0.1˜30 |
| (e.g. paradichlorobenzene, at least | | |
| one of insecticidal essential oils) | | |
| Organic solvent (e.g. kerosene) | 10˜60 | 15˜40 |
| Surfactant (e.g. polyoxyethylene | 0.5˜20 | 1˜15 |
| glycol fatty acid ester) | | |
| Gelling agent (e.g. kappa | 0.5˜5 | 1˜3 |
| carrageenan, agar, locust bean gum) | | |
| Preservative (e.g. Biosite) | 0.05˜1 | 0.1˜0.5 |
| Antioxidant | 0.05˜1 | 0.1˜0.5 |
| (e.g. dibutyl hydroxytoluene) | | |
| Fragrant material | 0.05˜1 | 0.1˜0.5 |
| Water (e.g. deionized water) | The rest | The rest |

TABLE 2
Formulation 2 of Insect Repellent Gel

| | | Preferred |
|---|---|---|
| | Blending | Blending |
| | Quantity | Quantity |
| Components | (weight %) | (weight %) |
| Volatile insect repellent | 0.01˜40 | 0.1˜30 |
| (e.g. paradichlorobenzene, at least | | |
| one of insecticidal essential oils) | | |
| Organic solvent (e.g. kerosene) | 10˜60 | 15˜40 |
| Surfactant (e.g. polyoxyethylene | 0.5˜20 | 1˜15 |
| glycol fatty acid ester) | | |
| Gelling agent (e.g. kappa | 0.5˜5 | 1˜3 |
| carrageenan, agar, locust bean gum) | | |
| Preservative (e.g. Biosite) | 0.05˜1 | 0.1˜0.5 |
| Antioxidant | 0.05˜1 | 0.1˜0.5 |
| (e.g. dibutyl hydroxytoluene) | | |
| Aldehyde Absorbent | 0.05˜1 | 0.1˜0.5 |
| (e.g. CHEMCATCH H-100 (Product Name; | | |
| by Otsuka Chemical Co., Ltd.) | | |
| White particles | 0.05˜1 | 0.1˜0.5 |
| (deodorizing component) | | |
| (e.g. dried aluminum hydroxide gel) | | |
| Fragrant material | 0.05˜1 | 0.1˜0.5 |
| Water (e.g. deionized water) | The rest | The rest |

TABLE 3
Formulation 1 of Charcoal-containing Gel

| | | Preferred |
|---|---|---|
| | Blending | Blending |
| | Quantity | Quantity |
| Components | (weight %) | (weight %) |
| Deodorizing/air freshening component | 0.5˜8 | 1˜3 |
| (e.g. carbon) | | |
| Agents to adjust the specific gravity | 1˜15 | 2˜10 |
| (e.g. aliphatic hydrocarbon, such as | | |
| isoparaffin, normal paraffin) | | |
| Emulsifying agent | 0.1˜4 | 0.5˜2 |
| (e.g. polyoxyethylene alkyl ether) | | |
| Preservative (e.g. Biosite) | 0.01˜1 | 0.05˜0.5 |
| Gelling agent (e.g. kappa | 0.5˜5 | 1˜3 |
| carrageenan, agar, locust bean gum) | | |
| Water (e.g. deionized water) | The rest | The rest |

TABLE 4
Formulation 2 of Charcoal-containing Gel

| | | Preferred |
|---|---|---|
| | Blending | Blending |
| | Quantity | Quantity |
| Components | (weight %) | (weight %) |
| Deodorizing/air freshening agent | 0.5˜8 | 1˜3 |
| (e.g. carbon) | | |
| Agents to adjust the specific gravity | 1˜15 | 2˜10 |
| (e.g. aliphatic hydrocarbon, such as | | |
| isoparaffin, normal paraffin) | | |
| Emulsifying agent | 0.1˜4 | 0.5˜2 |
| (e.g. polyoxyethylene alkyl ether) | | |
| Preservative | 0.01˜1 | 0.05˜0.5 |
| (e.g. Biosite) | | |
| Gelling agent (e.g. kappa | 0.5˜5 | 1˜3 |
| carrageenan, agar, locust bean gum) | | |
| Gel hardening agent | 0.01˜1.5 | 0.05˜1 |
| (e.g. xanthan gum, gellan | | |
| gum, , glucomannan) | | |
| Auxiliary agent for dissolution | 0.1˜5 | 0.5˜3 |
| (e.g. polyethyleneglycol) | | |
| Water (e.g. deionized water) | The rest | The rest |

Following are detailed description of the embodiments of the gel material of the present invention with reference to the drawings. The present invention should not be construed as being limited to the embodiments.

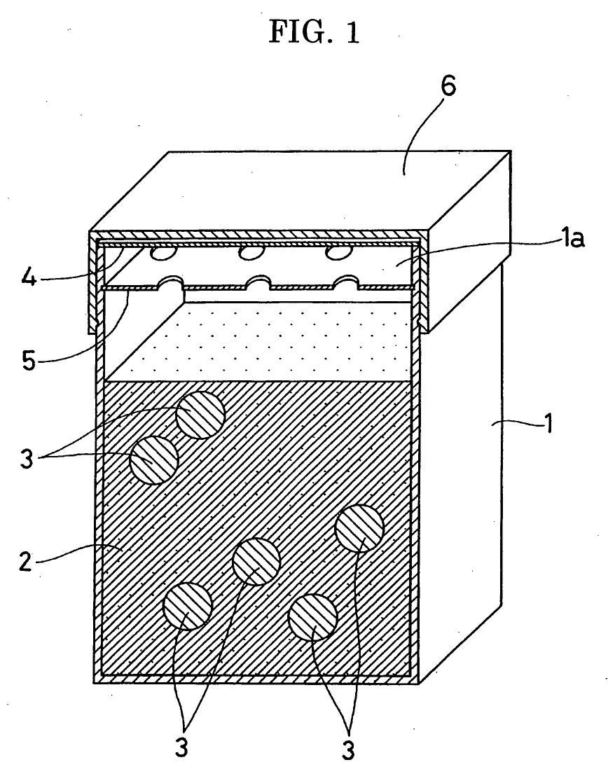

With reference to the gel material shown in FIG. 1, a gel 2 having a deodorizing function is filled in a container 1, and solid materials 3 comprised of charcoal are dispersed in the gel 2. An opening 1a of the container 1 is sealed with a sheet 4, which is unsealed when used, and a sheet 5 which is provided with holes for emission. The opening 1a is further sealed with a cap 6.

Before use, the cap 6 is removed from the container 1 and the sheet 4 is unsealed while the sheet 5 with the emission holes is left on the opening of the container sealed, thereby the gel material can demonstrate the deodorizing function to remove unfavorable odor in the air as well as air freshening, air cleaning and humidity controlling functions, which are peculiar to charcoal. The solid materials 3 comprised of charcoal include three types of solid materials that have the specific gravities equal to, and higher and lower than that of the gel. Therefore, the solid materials 3 are moderately dispersed in the gel 2.

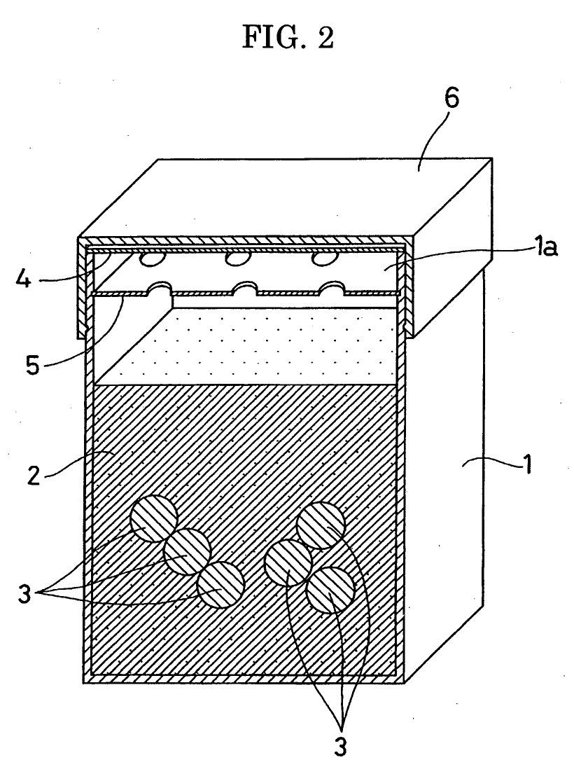

The gel material shown in FIG. 2 is the same as shown in FIG. 1, except that the container 1 is filled with a gel 2 having a micro-biocidal function and solid materials 3 comprised of resin are dispersed in the gel 2. In this embodiment the solid materials 3 comprised of resin include two types of solid materials that have the specific gravities equal to and higher than that of the gel. Therefore, the solid materials 3 can be moderately dispersed in the gel 2.

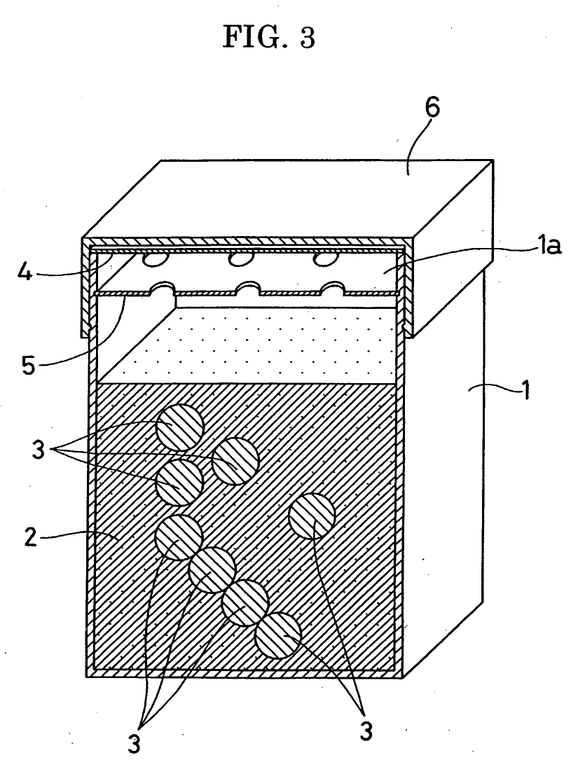

The gel material shown in FIG. 3 is the same as shown in FIG. 1, except that the container 1 is filled with a gel 2 having an insect repellent function and the solid materials 3 comprised of charcoal are dispersed in the gel 2. In this embodiment the gel material can efficiently demonstrate the effect peculiar to charcoal by increasing the number of the solid materials 3 comprised of charcoal because the solid materials 3 are gradually exposed when the volume of the gel 2 is reduced.

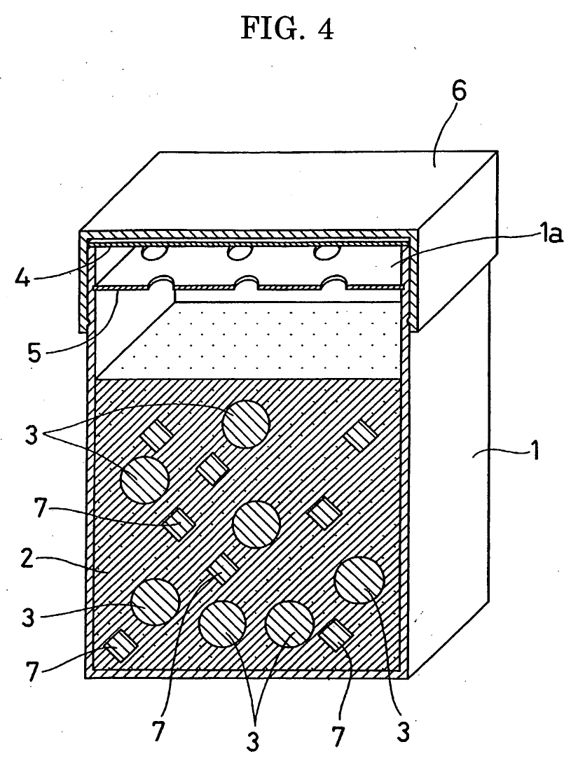

The gel material shown in FIG. 4 is the same as shown in FIG. 1, except that the container 1 is filled with a gel 2 having an insect repellent function and lamé materials 7 are dispersed in the gel 2 as well as the solid materials 3.

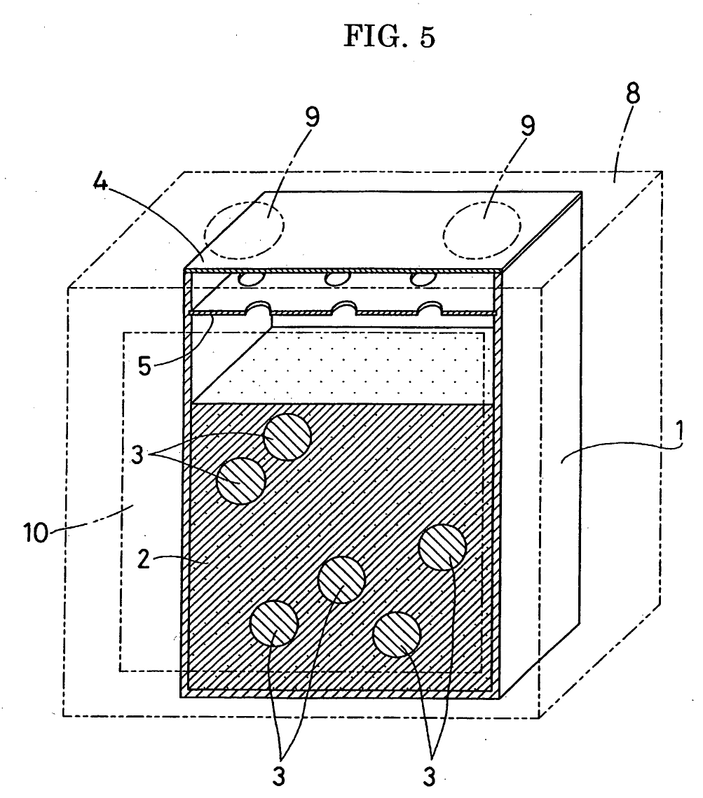

In the gel material shown in FIG. 5, a gel 2 having a micro-biocidal function is filled in a container 1, and solid materials 3 comprised of resin are dispersed in the gel 2. The container 1 is housed in an outer container 8, which is provided with a plurality of emission holes 9 on its topside and a large window 10 on its front side, through which it can be possible to observe how much the gel 2 reduces in the container 1. The container 1 has the same structure as shown in FIG. 1, except that the cap 6 is not provided.

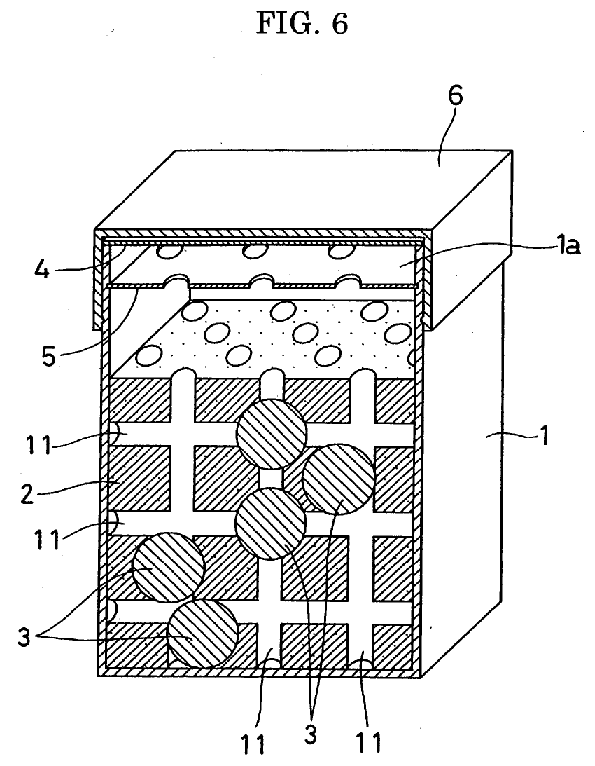

In the gel material shown in FIG. 6, a gel 2 having a deodorizing function is filled in a container 1, and solid materials 3 comprised of charcoal are dispersed in the gel 2. The gel 2 is further provided with holes 11 directly communicated with the ambient air in the longitudinal and/or lateral directions for the purpose of increasing the surface area of the gel 2 and the surface area exposed to the air, so that the gel material may directly exert its functions, such as an air freshening effect.

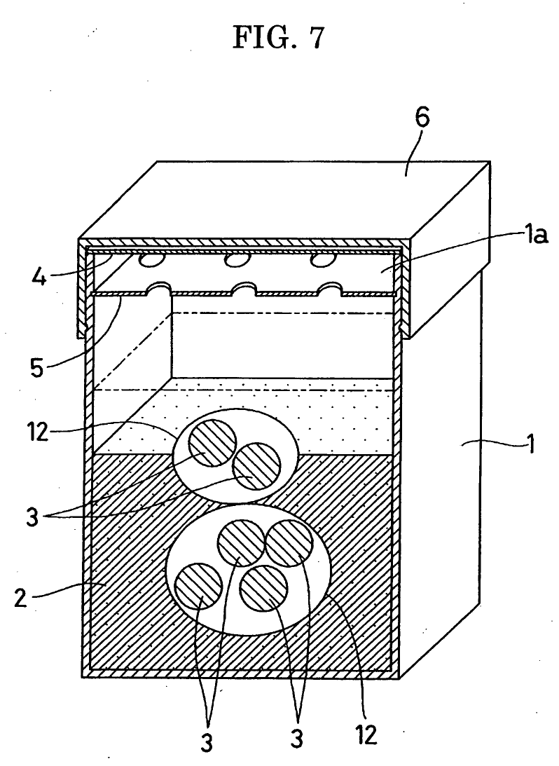

In the gel material shown in FIG. 7, a gel 2 having an insect repellent function is filled in a container 1, and solid materials 3 comprised of charcoal and being covered with an air-permeable membrane 12 (it may be possible to pack functional materials into a microporous membrane which is formed in a fish or animal shape or in a spherical or oval form as a three-dimensional package, or to pack functional materials into a microporous which is formed as a spherically molded membrane) are dispersed in the gel 2, so that the gel material may indirectly exert its functions, such as a deodorizing effect, through the air-permeable membrane 12.

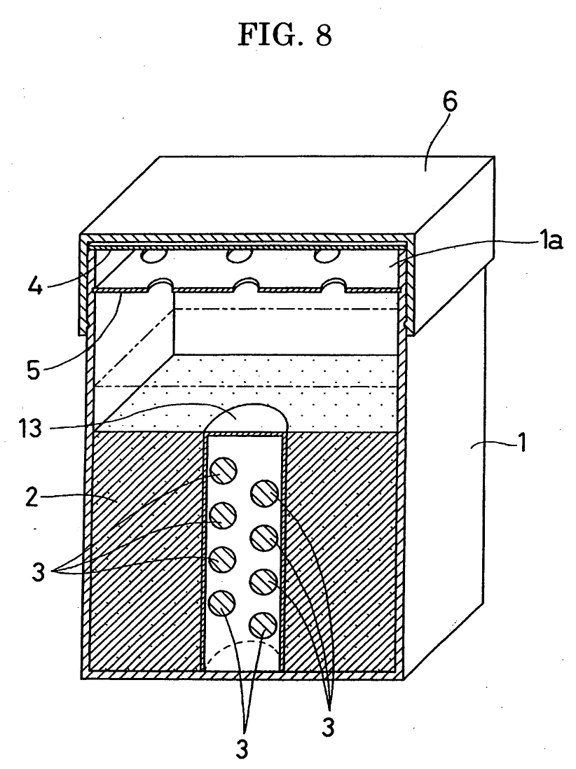

In the gel material shown in FIG. 8, a gel 2 having insect repellent function is filled in a container 1, and solid materials 3 comprised of charcoal and being covered with a air-permeable partition 13 (the gel is partitioned by a bottomless, covered tube into which the functional materials are isolated) are provided in the gel 2, so that the gel material may indirectly exert its functions, such as a deodorizing effect, through the air-permeable partition 13.

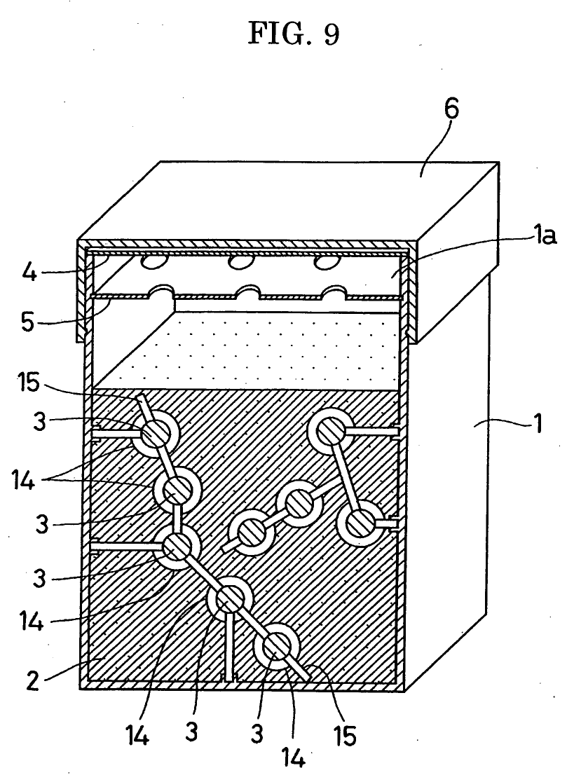

In the gel material shown in FIG. 9, a gel 2 having insect repellent function is filled in a container 1, and solid materials 3 comprised of charcoal are enclosed in air-permeable enclosures 14 (functional materials are isolated into spherical hollow cases which are molded from net, membrane and the like), and each solid material 3 is individually connected by skewers 15 to be positioned in the gel 2. In this embodiment, the gel material can indirectly exert its function of the solid materials 3, such as a deodorizing function, and the solid materials 3 can always be arranged at the same given positions by the positioning means.

What is claimed is:

1. A gel material comprising a gel and solid materials wherein the solid materials are moderately dispersed within the gel by using any means.

2. The gel material according to claim 1, wherein the solid materials are moderately dispersed within the gel by adjusting specific gravity of the solid materials with specific gravity of the gel.

3. The gel material according to claim 1, wherein the solid materials are moderately dispersed within the gel by being appropriately arranged by a positioning means.

4. The gel material according to any one of claims 1 to 3, further comprising lamé material.
